(19) United States
(12) Patent Application Publication
(10) Pub. No.: US 2024/0144416 A1
(43) Pub. Date: May 2, 2024

(54) OCCUPANCY GRID DETERMINATION

(71) Applicant: QUALCOMM Incorporated, San Diego, CA (US)

(72) Inventors: Makesh Pravin JOHN WILSON, San Diego, CA (US); Radhika Dilip GOWAIKAR, San Diego, CA (US); Volodimir SLOBODYANYUK, San Diego, CA (US); Avdhut JOSHI, San Marcos, CA (US); James POPLAWSKI, Canton, MI (US)

(21) Appl. No.: 18/477,893

(22) Filed: Sep. 29, 2023

Related U.S. Application Data
(60) Provisional application No. 63/380,978, filed on Oct. 26, 2022.

(51) Int. Cl. G06T 3/00; G06N 20/00; G06T 7/11; G08G 1/04

(52) U.S. Cl. CPC G06T 3/00; G06N 20/00; G06T 7/11; G08G 1/04; G06T 2207/20081; G06T 2207/30236

(57) ABSTRACT

An occupancy grid determination method includes: determining a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell; determining, using machine learning and based on the first sensor measurements, an observed occupancy grid comprising a plurality of second cells corresponding to the sub-regions of the region; and determining an updated occupancy grid based on the observed occupancy grid and the predicted occupancy grid.

### CROSS-REFERENCE TO RELATED APPLICATIONS

This application claims the benefit of U.S. Provisional Application No. 63/380,978, filed Oct. 26, 2022, entitled “OCCUPANCY GRID DETERMINATION,” which is assigned to the assignee hereof, and the entire contents of which are hereby incorporated herein by reference for all purposes.

### BACKGROUND

Vehicles are becoming more intelligent as the industry moves towards deploying increasingly sophisticated self-driving technologies that are capable of operating a vehicle with little or no human input, and thus being semi-autonomous or autonomous. Autonomous and semi-autonomous vehicles may be able to detect information about their location and surroundings (e.g., using ultrasound, radar, lidar, an SPS (Satellite Positioning System), and/or an odometer, and/or one or more sensors such as accelerometers, cameras, etc.). Autonomous and semi-autonomous vehicles typically include a control system to interpret information regarding an environment in which the vehicle is disposed to identify hazards and determine a navigation path to follow.

A driver assistance system may mitigate driving risk for a driver of an ego vehicle (i.e., a vehicle configured to perceive the environment of the vehicle) and/or for other road users. Driver assistance systems may include one or more active devices and/or one or more passive devices that can be used to determine the environment of the ego vehicle and, for semi-autonomous vehicles, possibly to notify a driver of a situation that the driver may be able to address. The driver assistance system may be configured to control various aspects of driving safety and/or driver monitoring. For example, a driver assistance system may control a speed of the ego vehicle to maintain at least a desired separation (in distance or time) between the ego vehicle and another vehicle (e.g., as part of an active cruise control system). The driver assistance system may monitor the surroundings of the ego vehicle, e.g., to maintain situational awareness for the ego vehicle. The situational awareness may be used to notify the driver of issues, e.g., another vehicle being in a blind spot of the driver, another vehicle being on a collision path with the ego vehicle, etc. The situational awareness may include information about the ego vehicle (e.g., speed, location, heading) and/or other vehicles or objects (e.g., location, speed, heading, size, object type, etc.).

A state of an ego vehicle may be used as an input to a number of driver assistance functionalities, such as an Advanced Driver Assistance System (ADAS). Downstream driving aids such as an ADAS may be safety critical, and/or may give the driver of the vehicle information and/or control the vehicle in some way.

### SUMMARY

An example apparatus includes: a memory; and a processor communicatively coupled to the memory, and configured to: determine a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell; determine, using machine learning and based on first sensor measurements, an observed occupancy grid comprising a plurality of second cells corresponding to the sub-regions of the region; and determine an updated occupancy grid based on the observed occupancy grid and the predicted occupancy grid.

An example occupancy grid determination method includes: determining a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell; determining, using machine learning and based on first sensor measurements, an observed occupancy grid comprising a plurality of second cells corresponding to the sub-regions of the region; and determining an updated occupancy grid based on the observed occupancy grid and the predicted occupancy grid.

Another example apparatus includes: means for determining a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell; means for determining, using machine learning and based on first sensor measurements, an observed occupancy grid comprising a plurality of second cells corresponding to the sub-regions of the region; and means for determining an updated occupancy grid based on the observed occupancy grid and the predicted occupancy grid.

An example non-transitory, processor-readable storage medium includes processor-readable instructions to cause a processor to: determine a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell; determine, using machine learning and based on first sensor measurements, an observed occupancy grid comprising a plurality of second cells corresponding to the sub-regions of the region; and determine an updated occupancy grid based on the observed occupancy grid and the predicted occupancy grid.

### BRIEF DESCRIPTION OF THE DRAWINGS

FIG. 1 is a top view of an example ego vehicle.

FIG. 2 is a block diagram of components of an example device, of which the ego vehicle shown in FIG. 1 may be an example.

FIG. 3 is a block diagram of components of an example transmission/reception point.

FIG. 4 is a block diagram of components of a server.

FIG. 5 is a block diagram of an example device.

FIG. 6 is a diagram of an example geographic environment.

FIG. 7 is a diagram of the geographic environment shown in FIG. 6 divided into a grid.

FIG. 8 is an example of an occupancy map corresponding to the grid shown in FIG. 7.

FIG. 9 is a block diagram of an example functional architecture for Bayesian filtering.

FIG. 10 is a block diagram of an example functional architecture for Bayesian filtering with measurements from multiple sensors.

FIG. 11 is another block diagram of an example functional architecture for Bayesian filtering with measurements from multiple sensors.

FIG. 12 is another block diagram of an example functional architecture for Bayesian filtering with measurements from multiple sensors.

FIG. 13 is another block diagram of an example functional architecture for Bayesian filtering with measurements from multiple sensors.

FIG. 14 is another block diagram of an example functional architecture for Bayesian filtering with measurements from multiple sensors.

FIG. 15 is a flow diagram for developing an image-to-occupancy-grid transformation.

FIG. 16 is a block flow diagram of an example occupancy grid determination method.

### DETAILED DESCRIPTION

Techniques are discussed herein for determining and using occupancy grids. For example, measurements from multiple sensors may be obtained and measurements from at least one of the sensors applied to an observation matrix determined using machine learning. Machine learning may be used to select which sensor measurement(s) to use for a particular cell of an observed occupancy grid determined from the sensor measurements, possibly using a combination of measurements from different sensors for the same observed occupancy grid cell. Machine learning may be used to select which occupancy grid cell(s) from one or more observed occupancy grids, each corresponding to a different sensor, to use for a particular cell of a present occupancy grid. The present occupancy grid may be used to update a predicted occupancy grid determined from a previous occupancy grid. Machine learning may be used to derive an image-to-occupancy-grid transformation to transform a camera image, or a set of arrays of information determined from the camera image, to an occupancy grid. Other techniques, however, may be used.

Items and/or techniques described herein may provide one or more of the following capabilities, as well as other capabilities not mentioned. Occupancy grid accuracy and/or reliability may be improved. Occupancy grids may be determined without losing a significant amount of, if any, information from a camera image. Probabilities, beliefs, and/or plausibility of an occupancy grid for dynamic occupancy grid cells may be better predicted. Other capabilities may be provided and not every implementation according to the disclosure must provide any, let alone all, of the capabilities discussed.

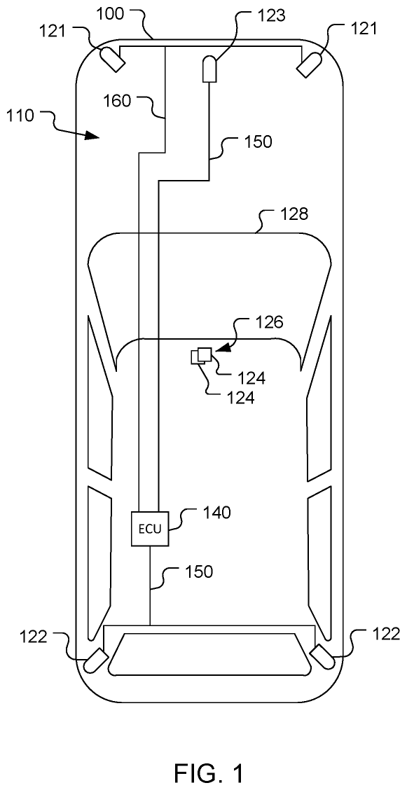

Referring to FIG. 1, an ego vehicle 100 includes an ego vehicle driver assistance system 110. The driver assistance system 110 may include a number of different types of sensors mounted at appropriate positions on the ego vehicle 100. For example, the system 110 may include: a pair of divergent and outwardly directed radar sensors 121 mounted at respective front corners of the vehicle 100, a similar pair of divergent and outwardly directed radar sensors 122 mounted at respective rear corners of the vehicle, a forwardly directed LRR sensor 123 (Long-Range Radar) mounted centrally at the front of the vehicle 100, and a pair of generally forwardly directed optical sensors 124 (cameras) forming part of an SVS 126 (Stereo Vision System) which may be mounted, for example, in the region of an upper edge of a windshield 128 of the vehicle 100. Each of the sensors 121 may include an LRR and/or an SRR (Short-Range Radar). The various sensors 121-124 may be operatively connected to a central electronic control system which is typically provided in the form of an ECU 140 (Electronic Control Unit) mounted at a convenient location within the vehicle 100. In the particular arrangement illustrated, the front and rear sensors 121, 122 are connected to the ECU 140 via one or more conventional Controller Area Network (CAN) buses 150, and the LRR sensor 123 and the sensors of the SVS 126 are connected to the ECU 140 via a serial bus 160 (e.g., a faster FlexRay serial bus).

Collectively, and under the control of the ECU 140, the various sensors 121-124 may be used to provide a variety of different types of driver assistance functionalities. For example, the sensors 121-124 and the ECU 140 may provide blind spot monitoring, adaptive cruise control, collision prevention assistance, lane departure protection, and/or rear collision mitigation.

The CAN bus 150 may be treated by the ECU 140 as a sensor that provides ego vehicle parameters to the ECU 140. For example, a GPS module may also be connected to the ECU 140 as a sensor, providing geolocation parameters to the ECU 140.

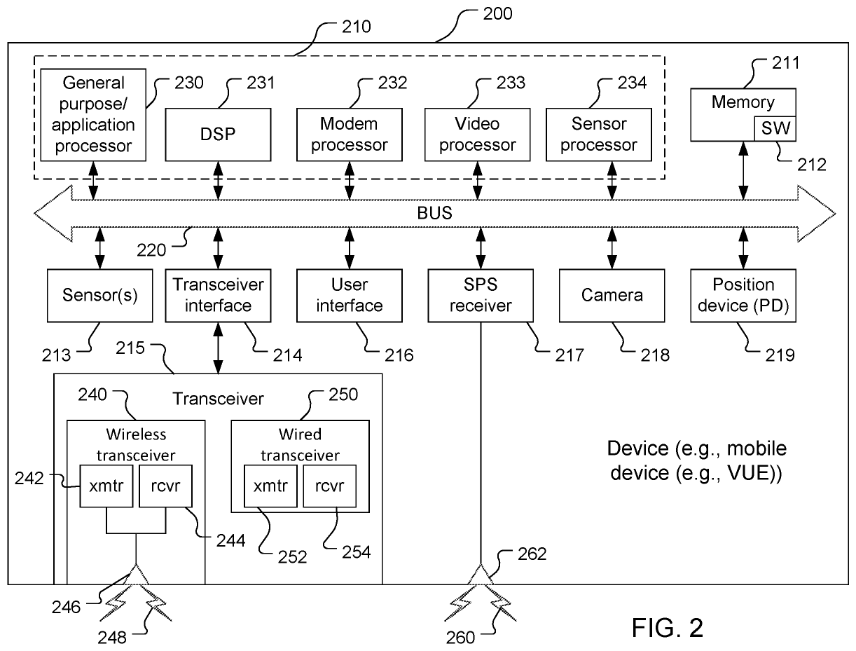

Referring also to FIG. 2, a device 200 (which may be a mobile device such as a user equipment (UE) such as a vehicle (VUE)) comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the device 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the device 200 for connectivity. The memory 211 is a non-transitory storage medium that may include random access memory (RAM), flash memory, disc memory, and/or read-only memory (ROM), etc. The memory 211 may store the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the device 200 performing a function as shorthand for one or more appropriate components of the device 200 performing the function. The processor 210 may include a memory with stored instructions in addition to and/or instead of the memory 211. Functionality of the processor 210 is discussed more fully below.

The configuration of the device 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The device 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The device 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the device 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the device 200 is fixed (stationary) or mobile and/or whether to report certain useful information, e.g., to an LMF (Location Management Function) regarding the mobility of the device 200. For example, based on the information obtained/measured by the sensor(s) 213, the device 200 may notify/report to the LMF that the device 200 has detected movements or that the device 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the device 200, etc.

The IMU may be configured to provide measurements about a direction of motion and/or a speed of motion of the device 200, which may be used in relative location determination. For example, one or more accelerometers and/or one or more gyroscopes of the IMU may detect, respectively, a linear acceleration and a speed of rotation of the device 200. The linear acceleration and speed of rotation measurements of the device 200 may be integrated over time to determine an instantaneous direction of motion as well as a displacement of the device 200. The instantaneous direction of motion and the displacement may be integrated to track a location of the device 200. For example, a reference location of the device 200 may be determined, e.g., using the SPS receiver 217 (and/or by some other means) for a moment in time and measurements from the accelerometer(s) and gyroscope(s) taken after this moment in time may be used in dead reckoning to determine present location of the device 200 based on movement (direction and distance) of the device 200 relative to the reference location.

The magnetometer(s) may determine magnetic field strengths in different directions which may be used to determine orientation of the device 200. For example, the orientation may be used to provide a digital compass for the device 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6GHz frequencies. The wired transceiver 250 may include a wired transmitter 252 and a wired receiver 254 configured for wired communication, e.g., a network interface that may be utilized to communicate with an NG-RAN (Next Generation-Radio Access Network) to send communications to, and receive communications from, the NG-RAN. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the device 200. For example, the user interface 216 may store indications of analog and/or digital signals in the memory 211 to be processed by DSP 231 and/or the general-purpose/application processor 230 in response to action from a user. Similarly, applications hosted on the device 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the device 200. For example, the SPS receiver 217 may be configured to determine location of the device 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the device 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the device 200.

The device 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the device 200, motion of the device 200, and/or relative position of the device 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the device 200 using terrestrial-based signals (e.g., at least some of the wireless signals 248) for trilateration, for assistance with obtaining and using the SPS signals 260, or both. The PD 219 may be configured to determine location of the device 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the device 200. The PD 219 may be configured to use one or more other techniques (e.g., relying on the UE's self-reported location (e.g., part of the UE's position beacon)) for determining the location of the device 200, and may use a combination of techniques (e.g., SPS and terrestrial positioning signals) to determine the location of the device 200. The PD 219 may include one or more of the sensors 213 (e.g., gyroscope(s), accelerometer(s), magnetometer(s), etc.) that may sense orientation and/or motion of the device 200 and provide indications thereof that the processor 210 (e.g., the general-purpose/application processor 230 and/or the DSP 231) may be configured to use to determine motion (e.g., a velocity vector and/or an acceleration vector) of the device 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the device 200, and may be provided by hardware, software, firmware, or various combinations thereof.

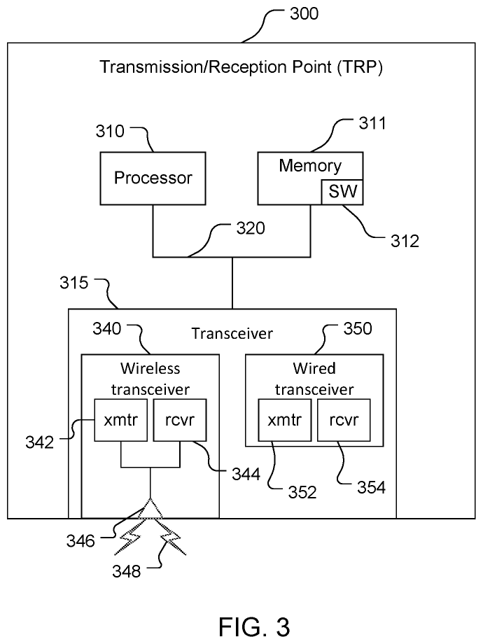

Referring also to FIG. 3, an example of a TRP 300 (e.g., of a base station such as a gNB (general NodeB) and/or an ng-eNB (next generation evolved NodeB) may comprise a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with an NG-RAN to send communications to, and receive communications from, an LMF, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by an LMF and/or the device 200 (i.e., an LMF and/or the device 200 may be configured to perform one or more of these functions).

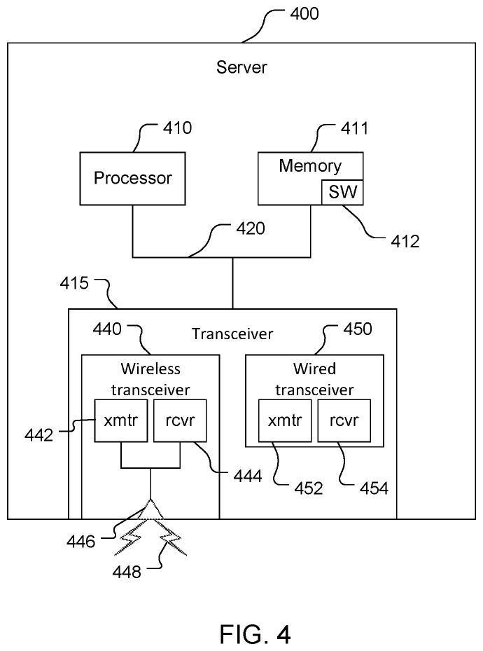

Referring also to FIG. 4, a server 400, of which an LMF is an example, may comprise a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with an NG-RAN to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the device 200 (i.e., the TRP 300 and/or the device 200 may be configured to perform one or more of these functions).

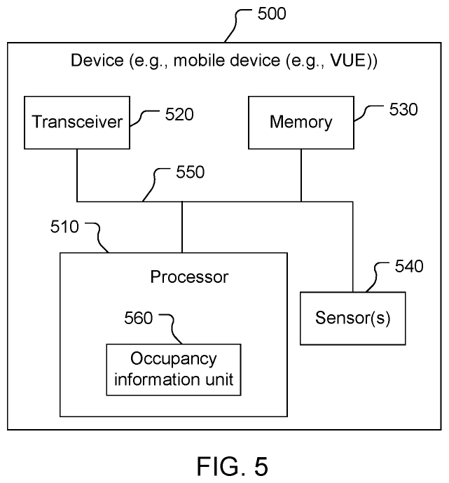

Referring to FIG. 5, a device 500 includes a processor 510, a transceiver 520, a memory 530, and sensors 540, communicatively coupled to each other by a bus 550. Even if referred to in the singular, the processor 510 may include one or more processors, the transceiver 520 may include one or more transceivers (e.g., one or more transmitters and/or one or more receivers), and the memory 530 may include one or more memories. The device 500 may take any of a variety of forms such as a mobile device such as a vehicle UE (VUE). The device 500 may include the components shown in FIG. 5, and may include one or more other components such as any of those shown in FIG. 2 such that the device 200 may be an example of the device 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the device 500 performing a function as shorthand for one or more appropriate components (e.g., the processor 510 and the memory 530) of the device 500 performing the function. The processor 510 (possibly in conjunction with the memory 530 and, as appropriate, the transceiver 520) may include an occupancy information unit 560 (which may include an ADAS (Advanced Driver Assistance System) for a VUE). The occupancy information unit 560 is discussed further herein, and the description herein may refer to the occupancy information unit 560 performing one or more functions, and/or may refer to the processor 510 generally, or the device 500 generally, as performing any of the functions of the occupancy information unit 560, with the device 500 being configured to perform the functions.

One or more functions performed by the device 500 (e.g., the occupancy information unit 560) may be performed by another entity. For example, sensor measurements (e.g., radar measurements, camera measurements (e.g., pixels, images)) and/or processed sensor measurements (e.g., a camera image converted to a bird's-eye-view image) may be provided to another entity, e.g., the server 400, and the other entity may perform one or more functions discussed herein with respect to the occupancy information unit 560 (e.g., using machine learning to determine and/or apply an observation model, analyzing measurements from different sensors to determine a present occupancy grid, etc.).

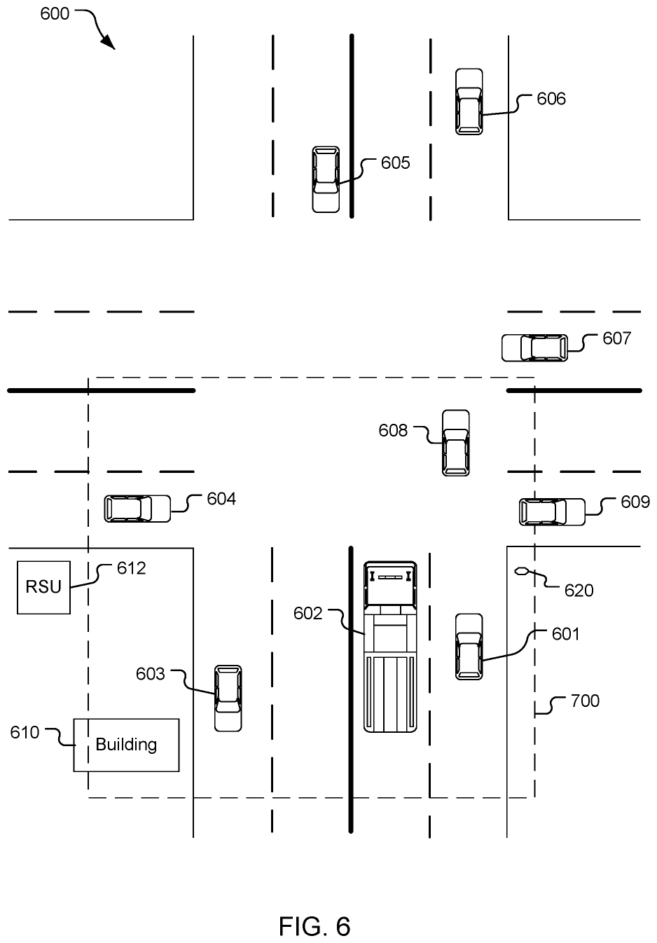

Referring also to FIG. 6, a geographic environment 600, in this example a driving environment, includes multiple mobile wireless communication devices, here vehicles 601, 602, 603, 604, 605, 606, 607, 608, 609, a building 610, an RSU 612 (Roadside Unit), and a street sign 620 (e.g., a stop sign). The RSU 612 may be configured similarly to the TRP 300, although perhaps having less functionality and/or shorter range than the TRP 300, e.g., a base-station-based TRP. One or more of the vehicles 601-609 may be configured to perform autonomous driving. A vehicle whose perspective is under consideration (e.g., for environment evaluation, autonomous driving, etc.) may be referred to as an observer vehicle or an ego vehicle. An ego vehicle, such as the vehicle 601 may evaluate a region around the ego vehicle for one or more desired purposes, e.g., to facilitate autonomous driving. The vehicle 601 may be an example of the device 500. The vehicle 601 may divide the region around the ego vehicle into multiple sub-regions and evaluate whether an object occupies each sub-region and if so, may determine one or more characteristics of the object (e.g., size, shape (e.g., dimensions (possibly including height)), velocity (speed and direction), object type (bicycle, car, truck, etc.), etc.).

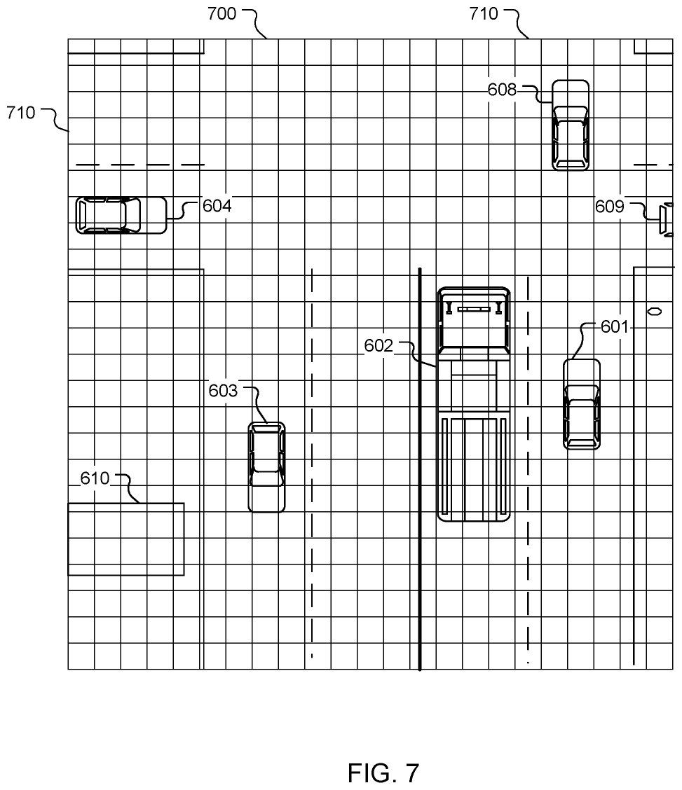

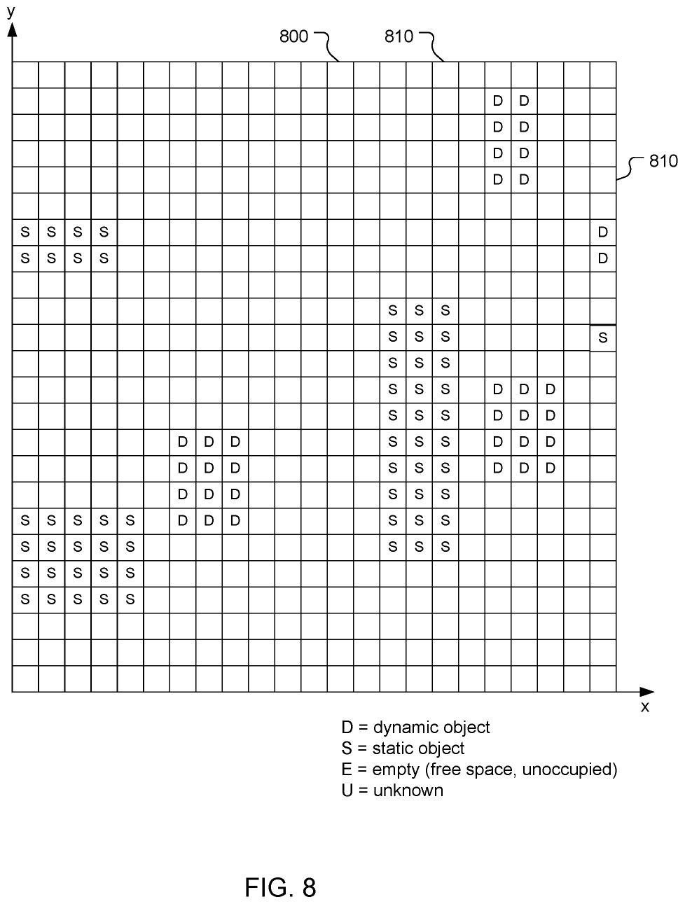

Referring also to FIGS. 7 and 8, a region 700, which in this example spans a portion of the environment 600, may be evaluated to determine an occupancy grid 800 (also called an occupancy map) that indicates an occupier type for each of multiple sub-regions of the region 700. For example, the region 700 may be divided into a grid, which may be called an occupancy grid, with sub-regions 710 that may be of similar (e.g., identical) size and shape, or may have two or more sizes and/or shapes (e.g., with sub-regions being smaller near an ego vehicle, e.g., the vehicle 601, and larger further away from the ego vehicle, and/or with sub-regions having different shape(s) near an ego vehicle than sub-region shape(s) further away from the ego vehicle). The region 700 and the grid 800 may be regularly-shaped (e.g., a rectangle, a triangle, a hexagon, an octagon, etc.) and/or may be divided into identically-shaped, regularly-shaped sub-regions for convenience sake, e.g., to simplify calculations, but other shapes of regions/grids (e.g., an irregular shape) and/or sub-regions (e.g., irregular shapes, multiple different regular shapes, or a combination of one or more irregular shapes and one or more regular shapes) may be used. For example, the sub-regions 710 may have rectangular (e.g., square) shapes. The region 700 may be of any of a variety of sizes and have any of a variety of granularities of sub-regions. For example, the region 700 may be a rectangle (e.g., a square) of about 100 m per side. As another example, while the region 700 is shown with the sub-regions 710 being squares of about 1 m per side, other sizes of sub-regions, including much smaller sub-regions, may be used. For example, square sub-regions of about 25 cm per side may be used. In this example, the region 700 is divided into M rows (here, 24 rows parallel to an x-axis indicated in FIG. 8) of N columns each (here, 23 columns parallel to a y-axis as indicated in FIG. 8).

Each of the sub-regions 710 may correspond to a respective cell 810 of the occupancy map and information may be obtained regarding what, if anything, occupies each of the sub-regions 710 in order to populate cells 810 of the occupancy map 800 with an occupancy indication indicative of a type of occupier of the sub-region corresponding to the cell. The information as to what, if anything, occupies each of the sub-regions 710 may be obtained from one or more of a variety of sources. For example, occupancy information may be obtained from one or more sensor measurements from one or more of the sensors 540 of the device 500. As another example, occupancy information may be obtained by one or more other devices and communicated to the device 500. For example, one or more of the vehicles 602-609 may communicate, e.g., via C-V2X communications, occupancy information to the vehicle 601. As another example, the RSU 612 may gather occupancy information (e.g., from one or more sensors of the RSU 612 and/or from communication with one or more of the vehicles 602-609 and/or one or more other devices) and communicate the gathered information to the vehicle 601, e.g., directly and/or through one or more network entities, e.g., TRPs.

As shown in FIG. 8, each of the cells 810 may include occupancy information indicating a type of occupier of the sub-region 710 corresponding to the cell 810. As examples, the occupancy information may indicate that the corresponding sub-region 710 is occupied by a static object (S), or may indicate that the corresponding sub-region 710 is occupied by a dynamic object (D) that is or may be mobile, or may indicate that the corresponding sub-region 710 is occupied by free space and is thus empty (E) or unoccupied, or may indicate that the occupancy of the corresponding sub-region is unknown (U), e.g., if there is no information as to a possible occupier of the corresponding sub-region 710. Each of the cells 810 may include respective probabilities of the cell 810 being static, dynamic, empty, or unknown, with a sum of the probabilities being 1. In the example shown in FIG. 8, empty cells are not labeled in the occupancy grid 800 for sake of simplicity of the figure and readability of the occupancy grid 800.

Building a dynamic occupancy grid (an occupancy grid with a dynamic occupier type) may be helpful, or even essential, for understanding an environment (e.g., the environment 600) of an apparatus to facilitate or even enable further processing. For example, a dynamic occupancy grid may be helpful for predicting occupancy, for motion planning, etc. A dynamic occupancy grid may, at any one time, comprise one or more cells of static occupier type and/or one or more cells of dynamic occupier type. A dynamic object may be represented as a collection of velocity vectors. For example, an occupancy grid cell may have some or all of the occupancy probability be dynamic, and within the dynamic occupancy probability, there may be multiple (e.g., four) velocity vectors each with a corresponding probability that together sum to the dynamic occupancy probability for that cell 810. A dynamic occupancy grid may be obtained, e.g., by the occupancy information unit 560, by processing information from multiple sensors, e.g., of the sensors 540, such as from a radar system, a camera, etc.

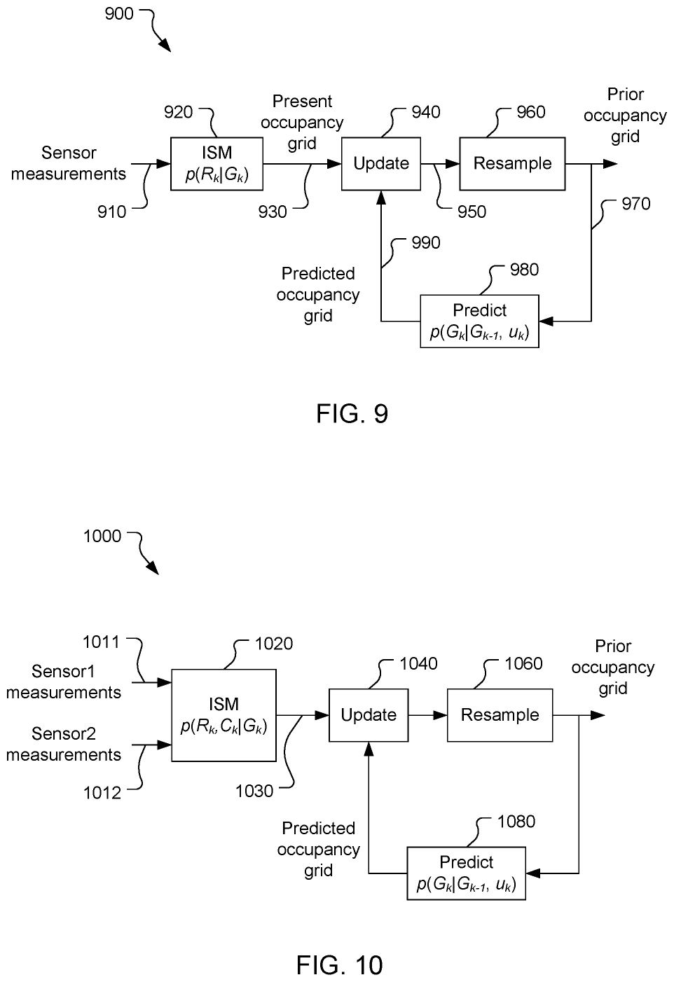

Referring also to FIG. 9, the occupancy information unit 560 may be configured to implement a Bayes Filter approach to predict occupancy grids and update occupancy grids based on an observation model. A functional architecture 900 illustrates Bayesian filtering. Sensor measurements 910 (e.g., radar measurements) may be used by an observation model function 920 (also called an ISM (Interpretive Structural Model) function) that uses a conditional probability of radar measurements and an occupancy grid to determine a present occupancy grid 930 (also called an observation occupancy grid). The occupancy information unit 560 may use the present occupancy grid 930 and a predicted occupancy grid 990 to perform an update function 940 of the predicted occupancy grid 990 to produce an updated occupancy grid 950 on which the occupancy information unit 560 may perform a resample function 960 to produce what then becomes a prior occupancy grid 970 that may be provided to any appropriate user of the updated occupancy grid (e.g., an autonomous driving application, a motion planner, etc.) and used for prediction of the next occupancy grid. The occupancy information unit 560 may use the prior occupancy grid 970 in a prediction function 980 to determine the predicted occupancy grid 990. The occupancy information unit 560 may perform the prediction function 980 according to

[symbol]

(Gₖ)=∫p(Gₖ|Gₖ₋₁, uₖ)bel(Gₖ₋₁)dGₖ₋₁ (1)

where Gₖ is an N×N occupancy grid at time k (i.e., the present occupancy grid 930), and is a dynamic occupancy grid (a DOGMa (Dynamic Occupancy Grid Map)), and may be implemented as a particle filter, Gₖ₋₁ is an occupancy grid at time k-1 (i.e., the prior occupancy grid 970), uₖ is action data, dGₖ is a differential element, bel(Gₖ₋₁) is the update for the prior occupancy grid, and p indicates probability. The occupancy information unit 560 may perform the update function 940 for the predicted occupancy grid 990 according to

bel(Gₖ)=ηp(Rₖ|Gₖ) [symbol] (Gₖ) (2)

where p(Rₖ|Gₖ) is the observation model for sensor measurements at time k (in this example, radar measurements Rₖ at time k), and η is a normalizing constant.

Referring also to FIG. 10, the occupancy information unit 560 may be configured to implement a Bayes Filter approach to predict occupancy grids and update occupancy grids based on an observation model that may use measurements from one or more of multiple sensors. A functional architecture 1000 illustrates a Bayes Filter approach implemented by the occupancy information unit 560 for sensor measurements from multiple sensors. The occupancy information unit 560 may perform an update function 1040, a resample function 1060, and a prediction function 1080 similar to the update function 940, the resample function 960, and the prediction function 980 discussed above. The prediction function 1080 and the update function 1040 may be replaced in some embodiments with an RNN (Recursive Neural Network)/LSTM (Long Short-Term Memory)/transformer architecture. Sensor measurements 1011, 1012 from multiple sensors (e.g., radar measurements, camera measurements (pixel measurements)) may be used in an observation model function 1020 implemented by the occupancy information unit 560 to determine a present occupancy grid 1030. The observation model function 1020 may include machine learning (e.g., may include a neural network (e.g., a CNN (Convolutional Neural Network)) to develop an observation model and apply the observation model to the sensor measurements 1011, 1012 to determine the present occupancy grid 1030. The occupancy information unit 560 may implement a neural network with respect to some sensor measurements and not others, e.g., implement a neural network with respect to camera measurements and not with respect to radar measurements (using a classical approach for the radar measurements), or vice versa. The occupancy information unit 560 may determine the present occupancy grid 1030 as p(Rₖ, Cₖ|Gₖ), and may implement various architectures to determine the present occupancy grid 1030. For example, the occupancy information unit 560 may determine the present occupancy grid 1030 as p(Rₖ, Cₖ|Gₖ) in accordance with any of the following relationships

p(Rₖ, Cₖ|Gₖ)−p(Rₖ|Gₖ)p(Cₖ|Rₖ, Gₖ) (3)

p(Rₖ, Cₖ|Gₖ)−p(Cₖ|Gₖ)p(Rₖ|Cₖ, Gₖ) (4)

p(Rₖ, Cₖ|Gₖ)−p(Rₖ|Gₖ)p(Cₖ|Gₖ) (5)

where Rₖ is a radar frame at time k, and Cₖ is a camera image at time k. A radar frame at time k may be composed of detection pings, where each ping may have attributes such as position, velocity, RCS (Radar Cross-Section), SNR (Signal-to-Noise Ratio), confidence level, etc. Each camera frame may be a grid (e.g., rectangular grid) of pixels representing RGB (red/green/blue) information (e.g., intensities). For Equation (5), there is an assumption that Gₖ is a sufficient statistic. In another embodiment, the occupancy information unit 560 may evaluate measurements from multiple sensors and selectively use the measurement from one sensor or the other, or a combination of the measurements. For example, if a radar measurement indicates a strong probability (e.g., 90%) of an object at a particular location but a camera measurement indicates a weak probability (e.g., 10%) of an object at that location, then the camera measurement may be discarded. In another example, if a radar measurement and a camera measurement both indicate significant probabilities (e.g., 40% and 60%) of an object at a location, then the occupancy information unit 560 may combine the measurements in some way, e.g., a weighted combination of the measurements.

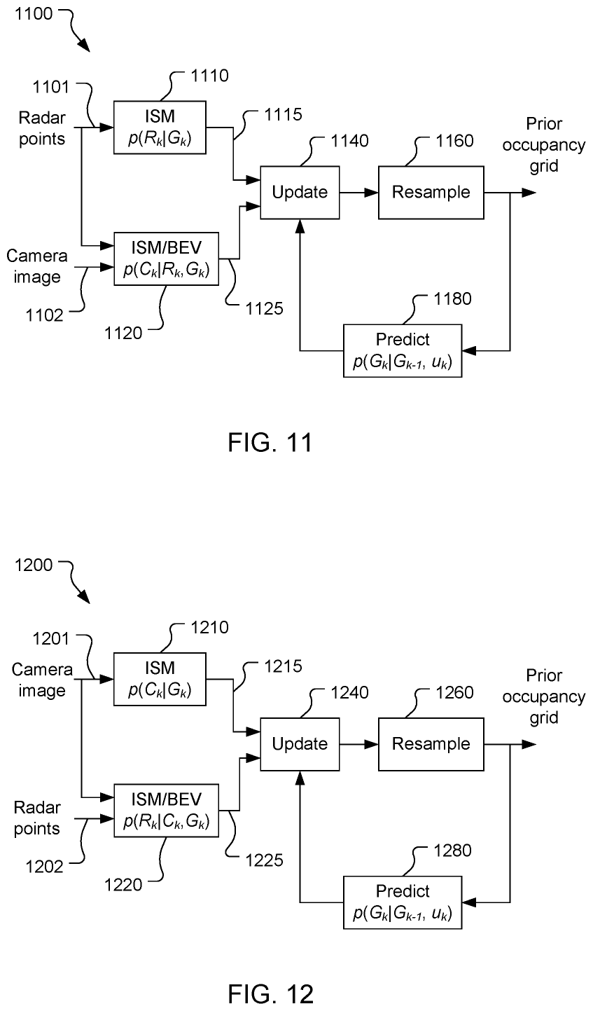

Referring also to FIG. 11, a functional architecture 1100 may be used to implement Equation (3) for multiple sensor measurement occupancy grid development and use. Implementation of Equation (3) may provide for joint processing of measurements from different sensors. In this example, and others discussed herein, radar points and camera images are used as examples of sensor measurements and a radar system and a camera as examples of sensors, but the discussion is applicable to one or more other sensors and corresponding sensor measurements. Also, in this example and others discussed herein, two sensors and corresponding measurements are used, but more than two sensors may be used. For example, one or more further observation model functions may be implemented, e.g., to consider other sensor measurements and/or other combinations of sensor measurements than observation model functions shown in FIG. 11. For example, an observation model function may consider measurements from a third sensor, an observation model may consider measurements from a camera and the third sensor, and/or an observation model may consider measurements from all available sensors, etc.

For the functional architecture 1100, the occupancy information unit 560 may be configured to implement an observation model function 1110 to apply an observation model to radar points 1101 to determine a single-sensor occupancy grid 1115 (here, a radar-based occupancy grid). The occupancy information unit 560 may also configured to implement an observation model function 1120 that may use machine learning to develop and apply an observation model of p(Cₖ|Rₖ,Gₖ) to the radar points 1101 and to a camera image 1102 to determine a multi-sensor occupancy grid 1125. The expression p(Cₖ|Rₖ,Gₖ) indicates an observation model that captures the probability of observing the camera image Cₖ given the observed radar frame Rₖ and grid state Gₖ. The probability of observation of a camera image changes based on the grid state and radar frame. For example, if all the cells in the grid are empty, then the probability of observing a camera image that includes vehicles will be very low and vice versa. The occupancy information unit 560 may combine the single-sensor occupancy grid 1115 and the multi-sensor occupancy grid 1125, e.g., by multiplying the single-sensor occupancy grid 1115 and the multi-sensor occupancy grid 1125. As another example, the occupancy information unit 560 may selectively use one or more portions of the single-sensor occupancy grid 1115 and/or selectively use one or more portions of the multi-sensor occupancy grid 1125 to determine a present occupancy grid for use in an update function 1140. For example, one or more portions of the single-sensor occupancy grid 1115 and one or more portions of the multi-sensor occupancy grid 1125 may be used to fill the present occupancy grid, with each cell of the present occupancy grid coming from one of the occupancy grids 1115, 1125. As another example, one or more of the cells of the present occupancy grid may each be determined using a corresponding cell of the single-sensor occupancy grid 1115 and a corresponding cell of the multi-sensor occupancy grid 1125, e.g., multiplying probabilities of the corresponding cells. The present occupancy grid and the predicted occupancy grid may be applied to the update function 1140 which may be similar to the update function 940, e.g., may multiply the present occupancy grid and the predicted occupancy grid. A resample function 1160 and a prediction function 1180 may be similar to the resample function 960 and the prediction function 980.

The occupancy information unit 560 may be configured to perform non-parametric camera image to a BEV (Bird's Eye View) conversion. For example, the occupancy information unit 560 may be configured to perform a non-parametric camera image to BEV conversion using IPM (Inverse Perspective Mapping) or using a flat road assumption. As another example, the occupancy information unit 560 may be configured to implement a data-aided and parametric (e.g., downlink-based) camera image to BEV conversion, e.g., by using camera image data collected while driving on roads to develop a BEV conversion model, e.g., using machine learning.

The functional architecture 1100 may be robust to sensor failures. For example, with the occupancy information unit 560 configured to implement the update function 1140 to selectively use the single-sensor occupancy grid and/or the multi-sensor occupancy grid 1125, or configured to selectively use one or more portions of the grid 1115 and/or one or more portions of the grid 1125, the functional architecture 1100 may adapt to sensor failures. For example the occupancy information unit 560 may avoid using measurements, and/or information derived therefrom, corresponding to a failing sensor.

Referring also to FIG. 12, a functional architecture 1200 may be used to implement Equation (4) for multiple sensor measurement occupancy grid development and use. For the functional architecture 1200, the occupancy information unit 560 may be configured to implement an observation model function 1210 to apply an observation model to a camera image 1201 to determine a single-sensor occupancy grid 1215 (here, a camera-based occupancy grid). The occupancy information unit 560 may also be configured to implement an observation model function 1220 that may use machine learning to develop and apply an observation model of p(Rₖ|Cₖ,Gₖ) to the camera image 1201 and to radar points 1202 to determine a multi-sensor occupancy grid 1225. The occupancy information unit 560 may combine the single-sensor occupancy grid 1215 and the multi-sensor occupancy grid 1225, e.g., as discussed above with respect to the single-sensor occupancy grid 1115 and the multi-sensor occupancy grid 1125. The occupancy information unit 560 may implement an update function 1240 similar to the update function 1140 or the update function 940. A resample function 1260 and a prediction function 1280 may be similar to the resample function 960 and the prediction function 980. The functional architecture 1200, like the functional architecture 1100, may be robust to sensor failures.

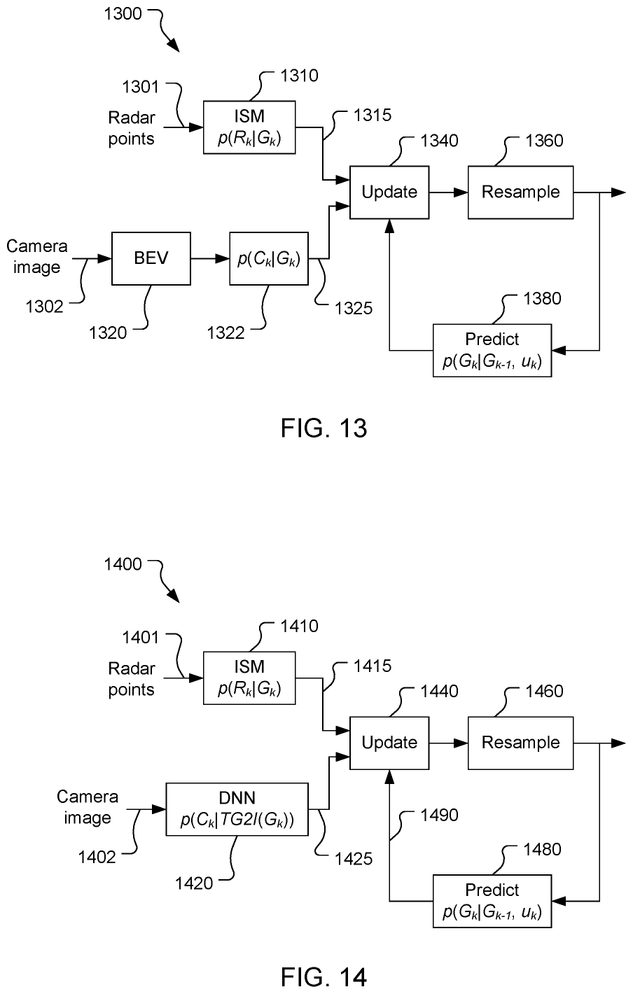

Referring also to FIG. 13, a functional architecture 1300 may be used to implement Equation (5) for multiple sensor measurement occupancy grid development and use by performing a camera image to BEV conversion. For the functional architecture 1300, the occupancy information unit 560 may implement an observation model function 1310 similar to the observation model function 1110 to operate on radar points 1301 to determine a radar-based occupancy grid 1315, and may implement a resample function 1360 and a prediction function 1380 similar to the resample function 1160 and the prediction function 1180, respectively. Also for the functional architecture 1300, the occupancy information unit 560 may be configured to implement a BEV function 1320 to convert a camera image 1302 to a bird's-eye-view depiction of the environment captured by the camera. For example, the occupancy information unit 560 may be configured to segment the camera image 1302 into a segmented image and apply a probability projection to the segmented image to derive the BEV. The occupancy information unit 560 may implement a DNN (Deep Neural Network) to perform an observation model function 1322 to determine an observation model p(Cₖ|Gₖ), with Cₖ being the BEV transformed image. The occupancy information unit 560 may apply the observation model function 1322 to the BEV to determine a camera-based occupancy grid 1325. The occupancy information unit 560 may implement an update function 1340, e.g., to multiply the radar-based occupancy grid 1315 and the camera-based occupancy grid 1325.

Referring also to FIG. 14, a functional architecture 1400 may be used to implement Equation (5) for multiple sensor measurement occupancy grid development and use by leveraging a grid-to-image conversion. For the functional architecture 1400, the occupancy information unit 560 may implement an observation model function 1410 similar to the observation model function 1110 to operate on radar points 1401 to determine a radar-based occupancy grid 1415, and may implement a resample function 1460 and a prediction function 1480 similar to the resample function 1160 and the prediction function 1180, respectively. Also for the functional architecture 1400, the occupancy information unit 560 may be configured to implement on observation model function 1420 by implementing a DNN to determine a camera-based occupancy grid 1415 based on a grid-to-image conversion. The occupancy information unit 560 may implement an update function 1440, e.g., to multiply the radar-based occupancy grid 1415 and the camera-based occupancy grid 1425.

Various architectures may be used for the observation model function 1420. For example, the occupancy information unit 560 may learn intrinsic camera characteristics (i.e., camera characteristics (e.g., lens quality, lens shape, light sensor quality, light sensor density, etc.) that affect captured images, e.g., quality of the images captured). The occupancy information unit 560 may, for example, apply a CNN to a captured image to perform a loss computation. The CNN may transform the image to a grid frame implicitly. As another example, the occupancy information unit 560 may apply a CNN to a captured image, and apply a transformation to a grid (e.g., by a VPN (View Parser Network) to determine a loss computation. As another example, the occupancy information unit 560 may apply a CNN encoder to a captured image, then apply a transformation to a grid, then apply a CNN decoder to determine a loss computation. For example, a PYVA (Projecting Your View Attentively) function may use a transformer for the transformation to the grid. As another example, the occupancy information unit 560 may use knowledge of intrinsic camera characteristics and extrinsic features (i.e., features extrinsic to the camera (e.g., shape of glass, e.g., a windshield, through which the camera captures images) that may affect captured images). For example, the occupancy information unit 560 may apply an IPM to the camera image, then apply a CNN including applying weighted heads to determine a loss computation. A CAM2BEV conversion may be performed that pairs IPM with a transformer, which may improve accuracy of this technique. As another example, with knowledge of intrinsic and extrinsic features, the occupancy information unit 560 may apply a CNN to a camera image, and apply weighted heads (discussed further below) to determine a loss computation with a grid-to-image frame transformation.

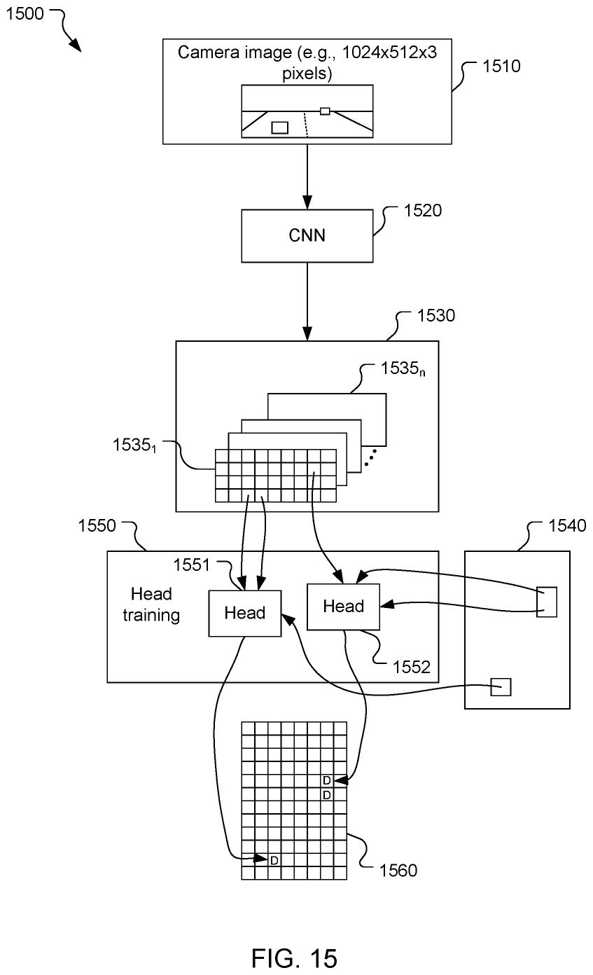

Referring also to FIG. 15, the occupancy information unit 560 may be configured to determine the camera-based occupancy grid based on a grid-to-image conversion. The occupancy information unit 560 may be configured to compute an observation model of p(Cₖ|G_{k,i}) where

p(Cₖ|G_{k,i})=p(Cₖ|TG2I(G_{k,i})) (6)

if the mapping from grid to image is invertible. As shown in FIG. 15, an observation model training method 1500 begins with the occupancy information unit 560 applying a camera image 1510 to a CNN 1520 to determine a set 1530 of arrays 1535₁-1535ₙ that comprise a modified image corresponding to the camera image 1510 (and thus to camera (sensor) measurements). Each of the arrays 1535₁-1535ₙ may have a lower resolution than the camera image 1510. For example, the camera image 1510 may comprise a 1024×512×3 pixel array, comprising a 1024×512 array of sets of three pixels each for red, green, and blue, and each of the arrays 1535₁-1535ₙ may comprise a reduced-resolution array of 128×62 cells. Each of the arrays 1535₁-1535ₙ may correspond to a different mechanism for deriving the respective array from the camera image 1510. For example, different arrays may be determined using different frequency filters, e.g., one array determined using an LPF (low-pass filter) and another array determined using an HPF (high-pass filter), or combinations thereof. Arrays may be determined using other distinguishing techniques. Each cell in each array will have a corresponding probability value. The occupancy information unit 560 may use a known occupancy grid 1540 corresponding to the camera image 1510 to perform a head training function 1550 to train heads, e.g., heads 1551, 1552, for converting the arrays 1535₁-1535ₙ to an expected occupancy grid 1560. Probabilities of the known occupancy grid 1540 will be either 1 or 0 because the ground truth is known, e.g., from lidar and/or one or more other techniques. The heads are weight vectors, of dimension l×n, that are part of a neural network implemented by the occupancy information unit 560 (e.g., part of the CNN 1520). The heads provide weightings for each of the arrays 1535₁-1535ₙ.

The occupancy information unit 560 may perform the head training function 1550 to determine values for the heads such that when the heads are applied to the arrays 1535₁-1535ₙ, the expected occupancy grid 1560 will adequately match the known occupancy grid 1540. To perform the head training function 1550, the occupancy information unit 560 may determine a grid-to-image conversion, and then determine an image-to-grid conversion as the inverse of the grid-to-image conversion. The occupancy information unit 560 may determine a conversion from the known occupancy grid 1540 to the arrays 1535₁-1535ₙ, and determine the inverse of this conversion as the image-to-grid conversion for converting the arrays 1535₁-1535ₙ (corresponding to the camera image 1510) to the expected occupancy grid 1560. The probability for a cell of the expected occupancy grid 1560 may be a sum of products of weights of the corresponding head and corresponding a corresponding cell (or cells) of each of the arrays 1535₁-1535ₙ. Pixels in the camera image 1510 may be selected based on the transformation by the CNN 1520.

The heads may be non-uniformly mapped to the arrays 1535₁-1535ₙ (and thus to pixels of the camera image 1510) and/or to the expected occupancy grid 1560. For example, multiple cells in each of the arrays 1535₁-1535ₙ corresponding to a nearby object (and multiple pixels in the camera image 1510) may map to a single cell of the expected occupancy grid and/or a single cell of each of the arrays 1535₁-1535ₙ (or even a single pixel of the camera image 1510) may map to multiple cells of the expected occupancy grid 1560. Consequently, a single head may be applied to multiple cells of each of the arrays 1535₁-1535ₙ and/or a head may map a single cell of each of the arrays 1535₁-1535ₙ to multiple cells of the expected occupancy grid 1560.

Heads can be determined to map directly from the camera image 1510 to the expected occupancy grid 1560. Using heads that map from the arrays 1535₁-1535ₙ to the expected occupancy grid may retain more information from the camera image 1510 than a mapping directly from the camera image 1510 to the expected occupancy grid 1560.

During an inference stage, the occupancy information unit 560 determines the arrays 1535₁-1535ₙ and applies the heads determined during training to the arrays 1535₁-1535ₙ to determine the expected occupancy grid 1560, which will be the camera-based occupancy grid 1425.

Referring again to FIG. 14, occupancy grids may be updated using the camera-based occupancy grid 1425 based on grid-to-image conversion. The prediction function 1480 may perform a prediction of a grid state to provide a predicted occupancy grid 1490 to the update function 1440. Each grid cell may include multiple state values, e.g., four state values corresponding to static, dynamic, empty, and unknown, with the dynamic state possibly having multiple sub-states (e.g., probabilities of different velocity vectors). The occupancy information unit 560 may run an inference on the camera image 1402 by applying the observation model function 1320 to compute p(Cₖ|G_{k,i}) for each grid cell (e.g., four values for each grid cell). The occupancy information unit 560 may compute a point-wise product for each grid cell by multiplying the predicted occupancy grid 1490 by the camera-based occupancy grid 1425 and the radar-based occupancy grid 1415 to produce an updated occupancy grid. The occupancy information unit 560 may normalize the probabilities for each grid cell of the updated occupancy grid such that a sum of the probabilities for each grid cell equals 1. The updated occupancy grid may be used to predict the next predicted occupancy grid, and so on.

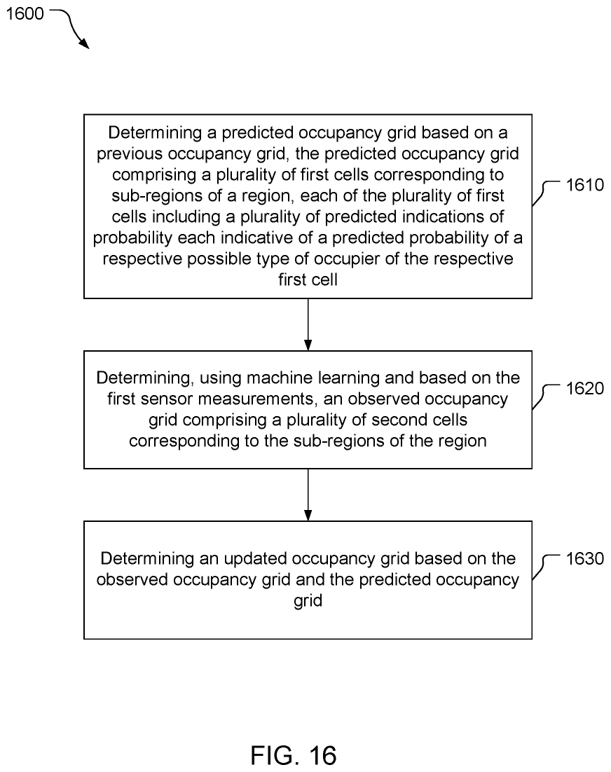

Referring to FIG. 16, with further reference to FIGS. 1-15, an occupancy grid determination method 1600 includes the stages shown. The method 1600 is, however, an example and not limiting. The method 1600 may be altered, e.g., by having one or more stages added, removed, rearranged, combined, performed concurrently, and/or having one or more stages each split into multiple stages.

At stage 1610, the method 1600 includes determining a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell. For example, the occupancy information unit 560 (or another entity such as the server 400) may perform any of the prediction functions 1080, 1180, 1280, 1380, 1480 to determine a predicted occupancy grid (e.g., the occupancy map 800). The processor 510, possibly in combination with the memory 530, or the processor 410 possibly in combination with the memory 411, may comprise means for determining the predicted occupancy grid.

At stage 1620, the method 1600 includes determining, using machine learning and based on first sensor measurements, an observed occupancy grid comprising a plurality of second cells corresponding to the sub-regions of the region. For example, the occupancy information unit 560 (or another entity) may perform any of the observation model functions 1020, 1120, 1220, 1322, 1420 to determine an observed occupancy grid, e.g., any of the occupancy grids 1030, 1125, 1225, 1325, 1425, respectively. The occupancy information unit 560 may also determine another observed occupancy grid without using machine learning (e.g., using a classical approach), e.g., any of the occupancy grids 1115, 1215, 1315, 1415, respectively. The processor 510, possibly in combination with the memory 530, or the processor 410 possibly in combination with the memory 411, may comprise means for determining the observed occupancy grid.

At stage 1630, the method 1600 includes determining an updated occupancy grid based on the observed occupancy grid and the predicted occupancy grid. For example, the occupancy information unit 560 (or other entity) may perform any of the update functions 1040, 1140, 1240, 1340, 1440 based on the occupancy grid 1030, or the occupancy grid 1125 (and possibly the occupancy grid 1115), or the occupancy grid 1225 (and possibly the occupancy grid 1215), or the occupancy grid 1325 (and possibly the occupancy grid 1315), or the occupancy grid 1425 (and possibly the occupancy grid 1415). The processor 510, possibly in combination with the memory 530, or the processor 410 possibly in combination with the memory 411, may comprise means for determining the updated occupancy grid.

Implementations of the method 1600 may include one or more of the following features. In an example implementation, the method 1600 includes obtaining the first sensor measurements from a first sensor; and obtaining second sensor measurements from a second sensor, wherein determining the observed occupancy grid comprises using, for each of the plurality of second cells, a respective first portion of first information corresponding to the first sensor measurements, a respective second portion of second information corresponding to the second sensor measurements, or a combination thereof. The first information may be sensor measurements (e.g., camera measurements for an image) or information derived from the sensor measurements (e.g., a BEV). The occupancy information unit 560 (or other entity) may obtain first and second sensor measurements, e.g., the sensor measurements 1011, 1012 (e.g., radar points and a camera image, respectively). The occupancy information unit 560 (or other entity) may analyze the sensor measurements and use none of the measurements from one sensor and thus only measurements from the other sensor, or use a combination of measurements from the sensors (e.g., using measurement(s) from one sensor or the other for a given cell of the observed occupancy grid, or combining measurements from different sensors to determine a given cell of the observed occupancy grid). The processor 510, possibly in combination with the memory 530, in combination with the sensors 540, or the processor 410 possibly in combination with the memory 411 and in combination with the wired receiver 454 and/or the wireless receiver 444 and the antenna 446, may comprise means for obtaining the first sensor measurements and means for obtaining the second sensor measurements. In a further example implementation, the first information comprises the first sensor measurements and the second information comprises the second sensor measurements, and wherein determining the observed occupancy grid comprises using, for each of the plurality of second cells, at least a first one of the first sensor measurements, at least a second one of the second sensor measurements, or a combination thereof. For example, for the observation model function 1020, the occupancy information unit 560 may select, for determining a given occupancy grid cell, one or more of the sensor measurements 1011 or one or more of the sensor measurements 1012, or a combination of at least one of the sensor measurements 1011 and at least one of the sensor measurements 1012. In another further example implementation, the method 1600 includes deriving the first information from the first sensor measurements and deriving the second information from the second sensor measurements. For example, in a further example implementation, the first information comprises a bird's-eye view of the region. In another further example implementation, the first information comprises a plurality of first indications of probability each indicative of a first probability of a first respective possible type of occupier of a respective one of the sub-regions and the second information comprises a plurality of second indications of probability each indicative of a second probability of a second respective possible type of occupier of a respective one of the sub-regions. For example, the first information may comprise one of the occupancy grids 1125, 1225, 1325, 1425 and the second information may comprise one of the occupancy grids 1115, 1215, 1315, 1415, and the update function 1140, 1240, 1340, 1440 may use, for any given cell of the updated occupancy grid, one or more cells of the occupancy grid 1115, 1215, 1315, 1415, or one or more cells of the occupancy grid 1125, 1225, 1325, 1425, or one or more cells of the occupancy grid 1115, 1215, 1315, 1415 and one or more cells of the occupancy grid 1125, 1225, 1325, 1425 (e.g., multiplying the respective cells). In another further example implementation, the method 1600 includes determining, through machine learning, an occupancy-grid-to-image transformation; determining an image-to-occupancy-grid transformation based on the occupancy-grid-to-image transformation; and determining the first information by applying the image-to-occupancy-grid transformation to third information corresponding to an image corresponding to the first sensor measurements, the first sensor comprising a camera. For example, as discussed with respect to FIG. 15, the occupancy information unit 560 (or other entity) may determine an occupancy-grid-to-image transformation based on the known occupancy grid 1540 to produce the arrays 1535₁-1535ₙ to an acceptable degree of accuracy. The inverse of the occupancy-grid-to-image transformation may be determined as an image-to-occupancy-grid transformation, and the first information (e.g., the occupancy grid 1425) may be determined by applying the image-to-occupancy-grid transformation to third information (e.g., a new set of arrays derived from a new camera image). Alternatively, the transformations may be to and from the camera image 1510 directly, such that the first information may be determined by applying the image-to-occupancy-grid transformation to a camera image. The processor 510, possibly in combination with the memory 530, or the processor 410 possibly in combination with the memory 411, may comprise means for determining the occupancy-grid-to-image transformation, means for determining the image-to-occupancy-grid transformation, and means for determining the first information. In a further example implementation, the occupancy-grid-to-image transformation maps between an occupancy grid, comprising a plurality of occupancy grid cells, and the third information, comprising a plurality of third-information regions, and the image-to-occupancy-grid transformation maps between the third information and the occupancy grid, and wherein: the occupancy-grid-to-image transformation maps at least two of the plurality of occupancy grid cells to a single pixel of the plurality of third-information regions; or the occupancy-grid-to-image transformation maps a single occupancy grid cell of the plurality of occupancy grid cells to at least two of the plurality of third-information regions; or the image-to-occupancy-grid transformation maps at least two of the plurality of third-information regions to a single one of the plurality of occupancy grid cells; or the image-to-occupancy-grid transformation maps a single one of the plurality of third-information regions to at least two of the plurality of occupancy grid cells; or a combination of two or more thereof; whereby there is a non-uniform mapping between the occupancy grid and the third information. For example, as discussed with respect to FIG. 15, there may be non-uniform mapping (many to one mapping (of cell(s) and/or pixel(s)) or one to many mapping (of cell(s) and/or pixel(s))) between the known occupancy grid 1540 and the arrays 1535₁-1535ₙ or the camera image 1510, and/or non-uniform mapping between the arrays 1535₁-1535ₙ (or the camera image 1510) and the expected occupancy grid 1560.

Also or alternatively, implementations of the method 1600 may include one or more of the following features. In an example implementation, the plurality of predicted indications of probability are each indicative of a plausibility of the respective possible type of occupier of the respective first cell actually occupying the respective first cell. For example, the predicted indications of probability may indicate probabilities of a cell being empty, unknown, occupied by a static object, or occupied by a dynamic object (and possibly sub-probabilities of different dynamic characteristics, e.g., different velocity vectors (of different direction and/or speed)).

### Implementation Examples

Implementation examples are provided in the following numbered clauses.

Clause 1. An apparatus comprising:
a memory; and
a processor communicatively coupled to the memory, and configured to:
   determine a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell;
   determine, using machine learning and based on first sensor measurements, an observed occupancy grid comprising a plurality of second cells corresponding to the sub-regions of the region; and
   determine an updated occupancy grid based on the observed occupancy grid and the predicted occupancy grid.

Clause 2. The apparatus of clause 1, further comprising:
a first sensor configured to obtain the first sensor measurements; and
a second sensor configured to obtain second sensor measurements;
wherein the processor is communicatively coupled to the first sensor and the second sensor, and wherein to determine the observed occupancy grid the processor is configured to use, for each of the plurality of second cells, a respective first portion of first information corresponding to the first sensor measurements, a respective second portion of second information corresponding to the second sensor measurements, or a combination thereof.

Clause 3. The apparatus of clause 2, wherein the first information comprises the first sensor measurements and the second information comprises the second sensor measurements, and wherein to determine the observed occupancy grid the processor is configured to use, for each of the plurality of second cells, at least a first one of the first sensor measurements, at least a second one of the second sensor measurements, or a combination thereof.

Clause 4. The apparatus of clause 2, wherein the first information is derived from the first sensor measurements and the second information is derived from the second sensor measurements.

Clause 5. The apparatus of clause 4, wherein the first information comprises a bird's-eye view of the region.

Clause 6. The apparatus of clause 4, wherein the first information comprises a plurality of first indications of probability each indicative of a first probability of a first respective possible type of occupier of a respective one of the sub-regions and the second information comprises a plurality of second indications of probability each indicative of a second probability of a second respective possible type of occupier of a respective one of the sub-regions.

Clause 7. The apparatus of clause 2, wherein the processor is further configured to:
determine, through machine learning, an occupancy-grid-to-image transformation;
determine an image-to-occupancy-grid transformation based on the occupancy-grid-to-image transformation; and
determine the first information by applying the image-to-occupancy-grid transformation to third information corresponding to an image corresponding to the first sensor measurements, the first sensor comprising a camera.

Clause 8. The apparatus of clause 7, wherein the occupancy-grid-to-image transformation maps between an occupancy grid, comprising a plurality of occupancy grid cells, and the third information, comprising a plurality of third-information regions, and the image-to-occupancy-grid transformation maps between the third information and the occupancy grid, and wherein:
the occupancy-grid-to-image transformation maps at least two of the plurality of occupancy grid cells to a single pixel of the plurality of third-information regions; or
the occupancy-grid-to-image transformation maps a single occupancy grid cell of the plurality of occupancy grid cells to at least two of the plurality of third-information regions; or
the image-to-occupancy-grid transformation maps at least two of the plurality of third-information regions to a single one of the plurality of occupancy grid cells; or
the image-to-occupancy-grid transformation maps a single one of the plurality of third-information regions to at least two of the plurality of occupancy grid cells; or
a combination of two or more thereof;
whereby there is a non-uniform mapping between the occupancy grid and the third information.

Clause 9. The apparatus of clause 1, wherein the plurality of predicted indications of probability are each indicative of a plausibility of the respective possible type of occupier of the respective first cell actually occupying the respective first cell.

Clause 10. An occupancy grid determination method comprising:
determining a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell;
determining, using machine learning and based on first sensor measurements, an observed occupancy grid comprising a plurality of second cells corresponding to the sub-regions of the region; and
determining an updated occupancy grid based on the observed occupancy grid and the predicted occupancy grid.

Clause 11. The occupancy grid determination method of clause 10, further comprising:
obtaining the first sensor measurements from a first sensor; and
obtaining second sensor measurements from a second sensor;
wherein determining the observed occupancy grid comprises using, for each of the plurality of second cells, a respective first portion of first information corresponding to the first sensor measurements, a respective second portion of second information corresponding to the second sensor measurements, or a combination thereof.

Clause 12. The occupancy grid determination method of clause 11, wherein the first information comprises the first sensor measurements and the second information comprises the second sensor measurements, and wherein determining the observed occupancy grid comprises using, for each of the plurality of second cells, at least a first one of the first sensor measurements, at least a second one of the second sensor measurements, or a combination thereof.

Clause 13. The occupancy grid determination method of clause 11, further comprising deriving the first information from the first sensor measurements and deriving the second information from the second sensor measurements.

Clause 14. The occupancy grid determination method of clause 13, wherein the first information comprises a bird's-eye view of the region.

Clause 15. The occupancy grid determination method of clause 13, wherein the first information comprises a plurality of first indications of probability each indicative of a first probability of a first respective possible type of occupier of a respective one of the sub-regions and the second information comprises a plurality of second indications of probability each indicative of a second probability of a second respective possible type of occupier of a respective one of the sub-regions.

Clause 16. The occupancy grid determination method of clause 11, further comprising:
determining, through machine learning, an occupancy-grid-to-image transformation;
determining an image-to-occupancy-grid transformation based on the occupancy-grid-to-image transformation; and
determining the first information by applying the image-to-occupancy-grid transformation to third information corresponding to an image corresponding to the first sensor measurements, the first sensor comprising a camera.

Clause 17. The occupancy grid determination method of clause 16, wherein the occupancy-grid-to-image transformation maps between an occupancy grid, comprising a plurality of occupancy grid cells, and the third information, comprising a plurality of third-information regions, and the image-to-occupancy-grid transformation maps between the third information and the occupancy grid, and wherein:
the occupancy-grid-to-image transformation maps at least two of the plurality of occupancy grid cells to a single pixel of the plurality of third-information regions; or
the occupancy-grid-to-image transformation maps a single occupancy grid cell of the plurality of occupancy grid cells to at least two of the plurality of third-information regions; or
the image-to-occupancy-grid transformation maps at least two of the plurality of third-information regions to a single one of the plurality of occupancy grid cells; or
the image-to-occupancy-grid transformation maps a single one of the plurality of third-information regions to at least two of the plurality of occupancy grid cells; or
a combination of two or more thereof;
whereby there is a non-uniform mapping between the occupancy grid and the third information.

Clause 18. The occupancy grid determination method of clause 10, wherein the plurality of predicted indications of probability are each indicative of a plausibility of the respective possible type of occupier of the respective first cell actually occupying the respective first cell.

Clause 19. An apparatus comprising:
means for determining a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell;
means for determining, using machine learning and based on first sensor measurements, an observed occupancy grid comprising a plurality of second cells corresponding to the sub-regions of the region; and
means for determining an updated occupancy grid based on the observed occupancy grid and the predicted occupancy grid.

Clause 20. The apparatus of clause 19, further comprising:
means for obtaining the first sensor measurements from a first sensor; and
means for obtaining second sensor measurements from a second sensor;
wherein the means for determining the observed occupancy grid comprise means for using, for each of the plurality of second cells, a respective first portion of first information corresponding to the first sensor measurements, a respective second portion of second information corresponding to the second sensor measurements, or a combination thereof.

Clause 21. The apparatus of clause 20, wherein the first information comprises the first sensor measurements and the second information comprises the second sensor measurements, and wherein the means for determining the observed occupancy grid comprise means for using, for each of the plurality of second cells, at least a first one of the first sensor measurements, at least a second one of the second sensor measurements, or a combination thereof.

Clause 22. The apparatus of clause 20, further comprising means for deriving the first information from the first sensor measurements and means for deriving the second information from the second sensor measurements.

Clause 23. The apparatus of clause 22, wherein the first information comprises a bird's-eye view of the region.

Clause 24. The apparatus of clause 22, wherein the first information comprises a plurality of first indications of probability each indicative of a first probability of a first respective possible type of occupier of a respective one of the sub-regions and the second information comprises a plurality of second indications of probability each indicative of a second probability of a second respective possible type of occupier of a respective one of the sub-regions.

Clause 25. The apparatus of clause 20, further comprising:
means for determining, through machine learning, an occupancy-grid-to-image transformation;
means for determining an image-to-occupancy-grid transformation based on the occupancy-grid-to-image transformation; and
means for determining the first information by applying the image-to-occupancy-grid transformation to third information corresponding to an image corresponding to the first sensor measurements, the first sensor comprising a camera.

Clause 26. The apparatus of clause 25, wherein the occupancy-grid-to-image transformation maps between an occupancy grid, comprising a plurality of occupancy grid cells, and the third information, comprising a plurality of third-information regions, and the image-to-occupancy-grid transformation maps between the third information and the occupancy grid, and wherein:
the occupancy-grid-to-image transformation maps at least two of the plurality of occupancy grid cells to a single pixel of the plurality of third-information regions; or
the occupancy-grid-to-image transformation maps a single occupancy grid cell of the plurality of occupancy grid cells to at least two of the plurality of third-information regions; or
the image-to-occupancy-grid transformation maps at least two of the plurality of third-information regions to a single one of the plurality of occupancy grid cells; or
the image-to-occupancy-grid transformation maps a single one of the plurality of third-information regions to at least two of the plurality of occupancy grid cells; or
a combination of two or more thereof;
whereby there is a non-uniform mapping between the occupancy grid and the third information.

Clause 27. The apparatus of clause 19, wherein the plurality of predicted indications of probability are each indicative of a plausibility of the respective possible type of occupier of the respective first cell actually occupying the respective first cell.

Clause 28. A non-transitory, processor-readable storage medium comprising processor-readable instructions to cause a processor to:
determine a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell;
determine, using machine learning and based on first sensor measurements, an observed occupancy grid comprising a plurality of second cells corresponding to the sub-regions of the region; and
determine an updated occupancy grid based on the observed occupancy grid and the predicted occupancy grid.

Clause 29. The non-transitory, processor-readable storage medium of clause 28, further comprising processor-readable instructions to cause the processor to:
obtain the first sensor measurements from a first sensor; and
obtain second sensor measurements from a second sensor;
wherein the processor-readable instructions to cause the processor to determine the observed occupancy grid comprise processor-readable instructions to cause the processor to use, for each of the plurality of second cells, a respective first portion of first information corresponding to the first sensor measurements, a respective second portion of second information corresponding to the second sensor measurements, or a combination thereof.

Clause 30. The non-transitory, processor-readable storage medium of clause 29, wherein the first information comprises the first sensor measurements and the second information comprises the second sensor measurements, and wherein the processor-readable instructions to cause the processor to determine the observed occupancy grid comprise processor-readable instructions to cause the processor to use, for each of the plurality of second cells, at least a first one of the first sensor measurements, at least a second one of the second sensor measurements, or a combination thereof.

Clause 31. The non-transitory, processor-readable storage medium of clause 29, further comprising processor-readable instructions to cause the processor to:
derive the first information from the first sensor measurements; and
derive the second information from the second sensor measurements.

Clause 32. The non-transitory, processor-readable storage medium of clause 31, wherein the first information comprises a bird's-eye view of the region.

Clause 33. The non-transitory, processor-readable storage medium of clause 31, wherein the first information comprises a plurality of first indications of probability each indicative of a first probability of a first respective possible type of occupier of a respective one of the sub-regions and the second information comprises a plurality of second indications of probability each indicative of a second probability of a second respective possible type of occupier of a respective one of the sub-regions.

Clause 34. The non-transitory, processor-readable storage medium of clause 29, further comprising processor-readable instructions to cause the processor to:
determine, through machine learning, an occupancy-grid-to-image transformation;
determine an image-to-occupancy-grid transformation based on the occupancy-grid-to-image transformation; and
determine the first information by applying the image-to-occupancy-grid transformation to third information corresponding to an image corresponding to the first sensor measurements, the first sensor comprising a camera.

Clause 35. The non-transitory, processor-readable storage medium of clause 34, wherein the occupancy-grid-to-image transformation maps between an occupancy grid, comprising a plurality of occupancy grid cells, and the third information, comprising a plurality of third-information regions, and the image-to-occupancy-grid transformation maps between the third information and the occupancy grid, and wherein:
the occupancy-grid-to-image transformation maps at least two of the plurality of occupancy grid cells to a single pixel of the plurality of third-information regions; or
the occupancy-grid-to-image transformation maps a single occupancy grid cell of the plurality of occupancy grid cells to at least two of the plurality of third-information regions; or
the image-to-occupancy-grid transformation maps at least two of the plurality of third-information regions to a single one of the plurality of occupancy grid cells; or
the image-to-occupancy-grid transformation maps a single one of the plurality of third-information regions to at least two of the plurality of occupancy grid cells; or
a combination of two or more thereof;
whereby there is a non-uniform mapping between the occupancy grid and the third information.

Clause 36. The non-transitory, processor-readable storage medium of clause 28, wherein the plurality of predicted indications of probability are each indicative of a plausibility of the respective possible type of occupier of the respective first cell actually occupying the respective first cell.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An apparatus comprising:
a memory; and
a processor communicatively coupled to the memory, and configured to:
determine a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell;
determine, using machine learning and based on first sensor measurements, an observed occupancy grid comprising a plurality of second cells corresponding to the sub-regions of the region; and
determine an updated occupancy grid based on the observed occupancy grid and the predicted occupancy grid.

2. The apparatus of claim 1, further comprising:
a first sensor configured to obtain the first sensor measurements; and
a second sensor configured to obtain second sensor measurements;
wherein the processor is communicatively coupled to the first sensor and the second sensor, and wherein to determine the observed occupancy grid the processor is configured to use, for each of the plurality of second cells, a respective first portion of first information corresponding to the first sensor measurements, a respective second portion of second information corresponding to the second sensor measurements, or a combination thereof.

3. The apparatus of claim 2, wherein the first information comprises the first sensor measurements and the second information comprises the second sensor measurements, and wherein to determine the observed occupancy grid the processor is configured to use, for each of the plurality of second cells, at least a first one of the first sensor measurements, at least a second one of the second sensor measurements, or a combination thereof.

4. The apparatus of claim 2, wherein the first information is derived from the first sensor measurements and the second information is derived from the second sensor measurements.

5. The apparatus of claim 4, wherein the first information comprises a bird's-eye view of the region.

6. The apparatus of claim 4, wherein the first information comprises a plurality of first indications of probability each indicative of a first probability of a first respective possible type of occupier of a respective one of the sub-regions and the second information comprises a plurality of second indications of probability each indicative of a second probability of a second respective possible type of occupier of a respective one of the sub-regions.

7. The apparatus of claim 2, wherein the processor is further configured to:
determine, through machine learning, an occupancy-grid-to-image transformation;
determine an image-to-occupancy-grid transformation based on the occupancy-grid-to-image transformation; and
determine the first information by applying the image-to-occupancy-grid transformation to third information corresponding to an image corresponding to the first sensor measurements, the first sensor comprising a camera.

8. The apparatus of claim 7, wherein the occupancy-grid-to-image transformation maps between an occupancy grid, comprising a plurality of occupancy grid cells, and the third information, comprising a plurality of third-information regions, and the image-to-occupancy-grid transformation maps between the third information and the occupancy grid, and wherein:
the occupancy-grid-to-image transformation maps at least two of the plurality of occupancy grid cells to a single pixel of the plurality of third-information regions; or
the occupancy-grid-to-image transformation maps a single occupancy grid cell of the plurality of occupancy grid cells to at least two of the plurality of third-information regions; or
the image-to-occupancy-grid transformation maps at least two of the plurality of third-information regions to a single one of the plurality of occupancy grid cells; or
the image-to-occupancy-grid transformation maps a single one of the plurality of third-information regions to at least two of the plurality of occupancy grid cells; or
a combination of two or more thereof;
whereby there is a non-uniform mapping between the occupancy grid and the third information.

9. The apparatus of claim 1, wherein the plurality of predicted indications of probability are each indicative of a plausibility of the respective possible type of occupier of the respective first cell actually occupying the respective first cell.

10. An occupancy grid determination method comprising:
determining a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell;
determining, using machine learning and based on first sensor measurements, an observed occupancy grid comprising a plurality of second cells corresponding to the sub-regions of the region; and
determining an updated occupancy grid based on the observed occupancy grid and the predicted occupancy grid.

11. The occupancy grid determination method of claim 10, further comprising:
obtaining the first sensor measurements from a first sensor; and
obtaining second sensor measurements from a second sensor;
wherein determining the observed occupancy grid comprises using, for each of the plurality of second cells, a respective first portion of first information corresponding to the first sensor measurements, a respective second portion of second information corresponding to the second sensor measurements, or a combination thereof.

12. The occupancy grid determination method of claim 11, wherein the first information comprises the first sensor measurements and the second information comprises the second sensor measurements, and wherein determining the observed occupancy grid comprises using, for each of the plurality of second cells, at least a first one of the first sensor measurements, at least a second one of the second sensor measurements, or a combination thereof.

13. The occupancy grid determination method of claim 11, further comprising deriving the first information from the first sensor measurements and deriving the second information from the second sensor measurements.

14. The occupancy grid determination method of claim 13, wherein the first information comprises a bird's-eye view of the region.

15. The occupancy grid determination method of claim 13, wherein the first information comprises a plurality of first indications of probability each indicative of a first probability of a first respective possible type of occupier of a respective one of the sub-regions and the second information comprises a plurality of second indications of probability each indicative of a second probability of a second respective possible type of occupier of a respective one of the sub-regions.

16. The occupancy grid determination method of claim 11, further comprising:
determining, through machine learning, an occupancy-grid-to-image transformation;
determining an image-to-occupancy-grid transformation based on the occupancy-grid-to-image transformation; and
determining the first information by applying the image-to-occupancy-grid transformation to third information corresponding to an image corresponding to the first sensor measurements, the first sensor comprising a camera.

17. The occupancy grid determination method of claim 16, wherein the occupancy-grid-to-image transformation maps between an occupancy grid, comprising a plurality of occupancy grid cells, and the third information, comprising a plurality of third-information regions, and the image-to-occupancy-grid transformation maps between the third information and the occupancy grid, and wherein:
the occupancy-grid-to-image transformation maps at least two of the plurality of occupancy grid cells to a single pixel of the plurality of third-information regions; or
the occupancy-grid-to-image transformation maps a single occupancy grid cell of the plurality of occupancy grid cells to at least two of the plurality of third-information regions; or
the image-to-occupancy-grid transformation maps at least two of the plurality of third-information regions to a single one of the plurality of occupancy grid cells; or
the image-to-occupancy-grid transformation maps a single one of the plurality of third-information regions to at least two of the plurality of occupancy grid cells; or
a combination of two or more thereof;
whereby there is a non-uniform mapping between the occupancy grid and the third information.

18. The occupancy grid determination method of claim 10, wherein the plurality of predicted indications of probability are each indicative of a plausibility of the respective possible type of occupier of the respective first cell actually occupying the respective first cell.

19. An apparatus comprising:
means for determining a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell;
means for determining, using machine learning and based on first sensor measurements, an observed occupancy grid comprising a plurality of second cells corresponding to the sub-regions of the region; and
means for determining an updated occupancy grid based on the observed occupancy grid and the predicted occupancy grid.

20. The apparatus of claim 19, further comprising:
means for obtaining the first sensor measurements from a first sensor; and
means for obtaining second sensor measurements from a second sensor;
wherein the means for determining the observed occupancy grid comprise means for using, for each of the plurality of second cells, a respective first portion of first information corresponding to the first sensor measurements, a respective second portion of second information corresponding to the second sensor measurements, or a combination thereof.

21. The apparatus of claim 20, wherein the first information comprises the first sensor measurements and the second information comprises the second sensor measurements, and wherein the means for determining the observed occupancy grid comprise means for using, for each of the plurality of second cells, at least a first one of the first sensor measurements, at least a second one of the second sensor measurements, or a combination thereof.

22. The apparatus of claim 20, further comprising means for deriving the first information from the first sensor measurements and means for deriving the second information from the second sensor measurements.

23. The apparatus of claim 22, wherein the first information comprises a bird's-eye view of the region.

24. The apparatus of claim 22, wherein the first information comprises a plurality of first indications of probability each indicative of a first probability of a first respective possible type of occupier of a respective one of the sub-regions and the second information comprises a plurality of second indications of probability each indicative of a second probability of a second respective possible type of occupier of a respective one of the sub-regions.

25. The apparatus of claim 20, further comprising:
means for determining, through machine learning, an occupancy-grid-to-image transformation;
means for determining an image-to-occupancy-grid transformation based on the occupancy-grid-to-image transformation; and
means for determining the first information by applying the image-to-occupancy-grid transformation to third information corresponding to an image corresponding to the first sensor measurements, the first sensor comprising a camera.

26. The apparatus of claim 25, wherein the occupancy-grid-to-image transformation maps between an occupancy grid, comprising a plurality of occupancy grid cells, and the third information, comprising a plurality of third-information regions, and the image-to-occupancy-grid transformation maps between the third information and the occupancy grid, and wherein:
the occupancy-grid-to-image transformation maps at least two of the plurality of occupancy grid cells to a single pixel of the plurality of third-information regions; or
the occupancy-grid-to-image transformation maps a single occupancy grid cell of the plurality of occupancy grid cells to at least two of the plurality of third-information regions; or
the image-to-occupancy-grid transformation maps at least two of the plurality of third-information regions to a single one of the plurality of occupancy grid cells; or
the image-to-occupancy-grid transformation maps a single one of the plurality of third-information regions to at least two of the plurality of occupancy grid cells; or
a combination of two or more thereof;
whereby there is a non-uniform mapping between the occupancy grid and the third information.

27. The apparatus of claim 19, wherein the plurality of predicted indications of probability are each indicative of a plausibility of the respective possible type of occupier of the respective first cell actually occupying the respective first cell.

28. A non-transitory, processor-readable storage medium comprising processor-readable instructions to cause a processor to:
determine a predicted occupancy grid based on a previous occupancy grid, the predicted occupancy grid comprising a plurality of first cells corresponding to sub-regions of a region, each of the plurality of first cells including a plurality of predicted indications of probability each indicative of a predicted probability of a respective possible type of occupier of the respective first cell;
determine, using machine learning and based on first sensor measurements, an observed occupancy grid comprising a plurality of second cells corresponding to the sub-regions of the region; and
determine an updated occupancy grid based on the observed occupancy grid and the predicted occupancy grid.

29. The non-transitory, processor-readable storage medium of claim 28, further comprising processor-readable instructions to cause the processor to:
obtain the first sensor measurements from a first sensor; and
obtain second sensor measurements from a second sensor;
wherein the processor-readable instructions to cause the processor to determine the observed occupancy grid comprise processor-readable instructions to cause the processor to use, for each of the plurality of second cells, a respective first portion of first information corresponding to the first sensor measurements, a respective second portion of second information corresponding to the second sensor measurements, or a combination thereof.

30. The non-transitory, processor-readable storage medium of claim 29, wherein the first information comprises the first sensor measurements and the second information comprises the second sensor measurements, and wherein the processor-readable instructions to cause the processor to determine the observed occupancy grid comprise processor-readable instructions to cause the processor to use, for each of the plurality of second cells, at least a first one of the first sensor measurements, at least a second one of the second sensor measurements, or a combination thereof.
